(19) United States
(12) Patent Application Publication
(10) Pub. No.: US 2023/0306514 A1
(43) Pub. Date: Sep. 28, 2023

(54) BOND AMORTIZATION AND ACCRETION REPORTING

(71) Applicant: Wells Fargo Bank, N.A., San Francisco, CA (US)

(72) Inventor: David Patrick Arana, Collinsville, IL (US)

(21) Appl. No.: 16/717,346

(22) Filed: Dec. 17, 2019

(51) Int. Cl. G06Q 40/06

(52) U.S. Cl. CPC G06Q 40/06

(57) ABSTRACT

Various examples described herein are directed to systems and methods for generating a bond amortization/accretion statement. A yield to maturity (YTM) value is determined based on a face value and a purchase price of a security where a balance based on the YTM value is determined. The balance is compared with the face value of the security where a number of direction changes of the balance relative to the face value is determined. A direction change occurs when a value of the balance changes relative to the face value. The YTM value is adjusted based on the number of direction changes and the value of the balance relative to the face value. A statement is generated based on the adjusted YTM value, the face value, and the purchase price and then output for display on a user device.

### BACKGROUND

A bond is a debt security that pays the holder of the bond a fixed amount on a regular basis. Bonds are brought to market by either government entities or corporations. Government entities issue bonds in order to raise capital for infrastructure or pay down debt. Corporations issue bonds to raise capital for various business purposes, such as expanding product lines and the like. Bonds are typically traded in a bond market, in either the primary market, where new debt is rolled out, or the secondary market, where investors may purchase existing bonds via third parties, such as brokers.

Since a bonds pays the holder a fixed amount for a certain period of time, the bond market is directly impacted by expectations about economic growth and inflation. For example, if inflation is expected to increase, investors will pay less for bonds since the expectation is that inflation will erode the value of the bond during the time period within which the fixed amount is paid. If lower inflation is expected, investors will pay more for bonds.

Investors typically measure the value of a bond based, in part, on the expected yield of a bond. A lower priced bond corresponds to higher yields while a higher priced bond corresponds to a lower yield. For example, a bond may have a coupon rate of 7% when purchased at face value. However, if an investor purchases this bond at 98% of the value of the bond, i.e., less than the face value, the investor will have a yield to maturity (YTM) that is higher than the coupon rate of 7%. On the other hand, an investor who purchases the same bond at 110% of the face value of the bond will have a YTM that is less than the coupon rate of 7%. In essence, the rate of return an investor receives on their bond is function of the face value of the bond, the coupon rate of the bond, and the actual purchase price of the bond.

In the instance where the investor purchases a bond at 110% of the face value, the investor may wish to amortize the bond for given period of time for tax purposes. Typically, the YTM may be used for bond amortization. For example, if a consumer were to buy a bond having a face value of $10,000 for $10,300, the $300 may be amortized down to $10,000 up to the first call date, the call prepayment date, or the term date, whichever occurs first. However, in order to amortize the bond, the YTM needs to be accurately calculated. Often, estimators are used to estimate the YTM. A standard estimator calculates the YTM as a function of coupon rate, the face value of the bond, the price paid for the bond, payment frequency, and the number of years to maturity. However, this is only an estimate of the YTM. In order to calculate the correct YTM, trial and error must be used, which is time consuming and resource intensive.

Accordingly, what is needed is a machine that accurately outputs a YTM while minimizing the resources necessary to make this determination.

### SUMMARY

Embodiments of the present disclosure relate to a computing device that calculates a YTM. In accordance with some embodiments, the YTM may be determined in order to calculate bond amortization for the given period of time. When an investor purchases a bond for an amount different from the face value of the bond, the YTM of the bond will differ from the coupon rate of the bond. Embodiments of the present invention determine the actual YTM based on the coupon rate in order to amortize the bond over a given period of time. In accordance with embodiments of the present disclosure, the YTM may also be used to determine accretion of the bond over a given period of time when the bond is purchased below face value. In an embodiment, an estimator is used to calculate an initial YTM. According to an embodiment, a balance, which reflects the value of the bond based on the YTM, is then generated using the initial YTM. According to an embodiment of the present disclosure, the balance is compared with the face value of the bond. In an embodiment, if the balance is lower than the face value of the bond, the YTM is incremented and a new balance is determined. In an embodiment, if the balance is greater than the face value of the bond, the YTM is decreased. In an embodiment, a new balance is then determined using either the increased or decreased YTM and the process of comparing the new balance with the face value of the bond and either increasing or decreasing the YTM is repeated until the balance equals the face value of the bond. The YTM used to determine the balance that is equal to the face value of the bond is used for amortization or accretion purposes.

### BRIEF DESCRIPTION OF THE DRAWINGS

FIG. 1 shows an environment in which embodiments of the present may operate.

FIGS. 2A and 2B illustrate a method of calculating a YTM using a processor of a YTM computing device in accordance with an embodiment of the present disclosure.

FIGS. 3A and 3B illustrate an output of balance values using YTM values determined in accordance with embodiments of the present disclosure.

FIG. 4 shows an output of an amortization statement that may be output and displayed on a user device in accordance with embodiments of the present disclosure.

FIG. 5 is a block diagram showing one example of a software architecture for a computing device, in accordance with an embodiment of the present disclosure.

FIG. 6 is a block diagram illustrating a computing device hardware architecture, within which a set or sequence of instructions can be executed to cause the machine to perform examples of any one of the methodologies discussed herein, in accordance with an embodiment of the present disclosure.

### DETAILED DESCRIPTION

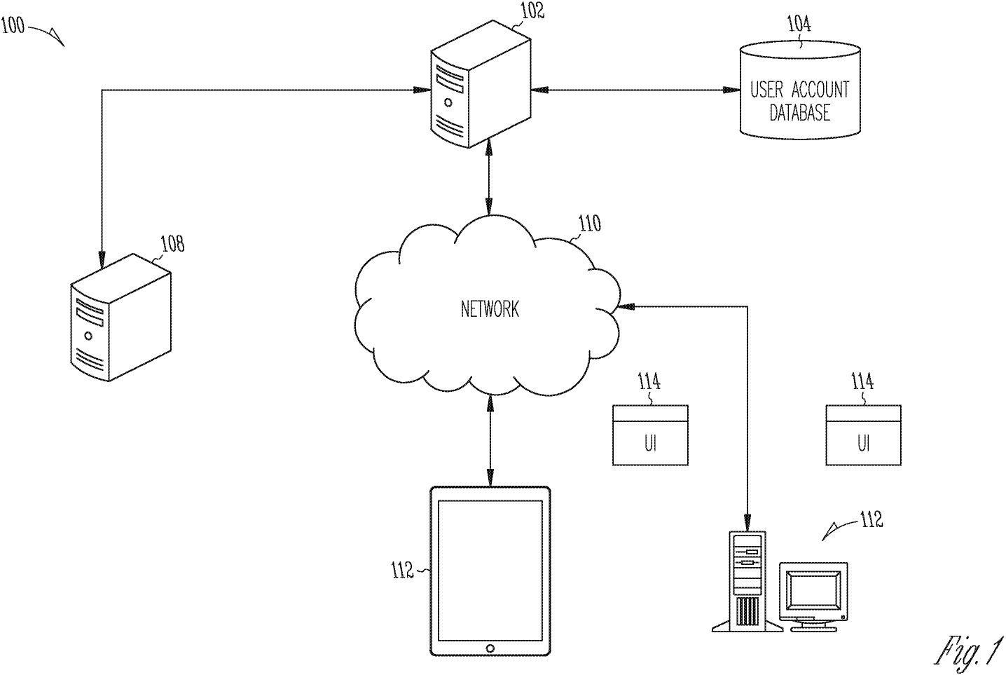

Now making reference to the Figures, and more specifically FIG. 1, an environment 100 is shown in which embodiments of the present may operate. The environment 100 includes a YTM computing device 102 in communication with a user account database 104, an amortization scheduling device 108, and a network 110. Via the network 110, the YTM computing device 102 communicates with user devices 112 and provides user interfaces (UIs) 114 for display on the user devices 112.

As will be discussed in greater detail below, each of the YTM computing device 102 and the amortization scheduling device 108 may incorporate an architecture that facilitates operation in the capacity of either a server of a client machine in server-client network environments, where each of these devices may be implemented as any type of computing device, such as a server computer, a personal computer (PC), or the like each having a processor configured to perform the subject matter disclosed herein. The user account database 104 may be any data storage resource and may store data structured as a text file, a table, a spreadsheet, a relational database (e.g., an object-relational database), a triple store, a hierarchical data store, or any suitable combination thereof.

The network 110 may be any network that enables communication between or among machines, databases, and devices (e.g., the YTM computing device 102 and the user devices 112). Accordingly, the network 110 may be a wired network, a wireless network (e.g., a mobile or cellular network), or any suitable combination thereof. The network 110 may include one or more portions that constitute a private network, a public network (e.g., the Internet), or any suitable combination thereof. Accordingly, the network 110 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 110 may communicate information via a transmission medium. As used herein, “transmission medium” shall be taken to include any intangible medium that is capable of storing, encoding, or carrying instructions for execution by a machine, and includes digital or analog communication signals or other intangible media to facilitate communication of such software.

The user devices 112 may be any computing device suitable for use by a user. For example, the user devices may be a desktop computer, a tablet computer, a portable media device, or a smart phone belonging to a user. The UIs 114 may be a graphical user interface that allows a user to directly interact with electronic devices, such as the user devices 112, through graphical elements, such as icons, and/or audio indicators, where the actions in the UIs 114 are performed through direct manipulation of the graphical elements. In addition, the UIs 114 are capable of displaying information received from the YTM computing device 102 on the user device 112.

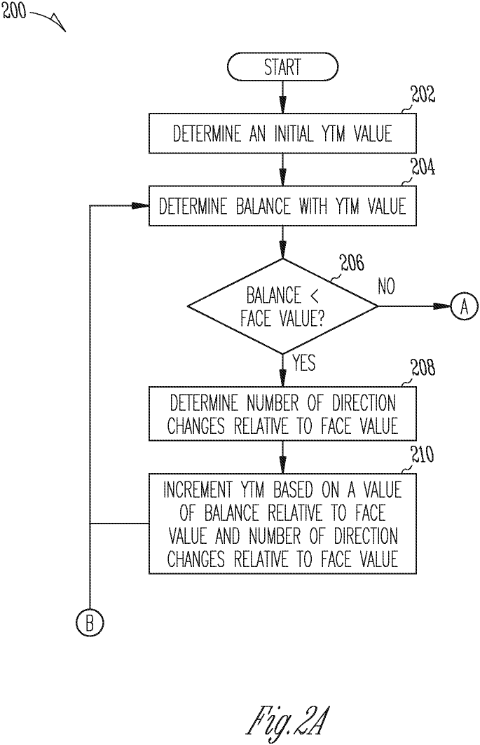

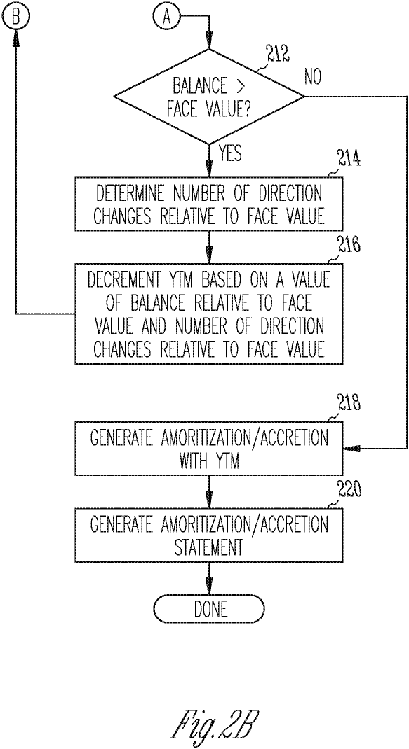

In accordance with embodiments of the present disclosure, the YTM computing device 102 calculates bond amortization or accretion for a given period of time for a bond purchased by an investor, such as a user associated with any of the user devices 112. The YTM computing device 102 determines a YTM in order to calculate the bond amortization or accretion for the given period of time. The YTM computing device 102 may determine an actual YTM based on the coupon rate in order to amortize or accrete the bond over a given period of time when the bond is purchased for an amount different from the face value of the bond. An example of this is described in further detail with reference to FIGS. 2A and 2B.

FIG. 2A illustrates a method 200 of calculating a YTM using a processor of the YTM computing device 102 in accordance with an embodiment of the present disclosure. At an operation 202, an initial YTM value is generated by the YTM computing device 102. In particular, an initial YTM value is selected using a function, such as the FINANCE Function in the Statistical Analysis System software available from SAS Institute Inc., located in Cary, North Carolina. The function computes a yield on a security that pays periodic interest, such as a bond. In accordance with an embodiment, the initial YTM is selected as a function of a settlement date of a security, such as the settlement date of a bond, the maturity date of the security, and an interest rate, i.e., coupon rate, of the security. In addition to these parameters, the initial YTM is selected based on a purchase price of the security per $100 of face value, a redemption of a security, which corresponds to the amount to be received when the security matures, and the frequency at which coupon payments are made per year. Moreover, in an embodiment, the initial YTM is calculated based on an optional day count value. In some embodiments, the YTM computing device 102 will determine the initial YTM. In other embodiments, the amortization scheduling device 1088 determines the initial YTM.

For example, assume a bond having a face value of $1,000,000 and a coupon rate of 7.5% is purchased for $1,038,790 on Sep. 24, 2018. Furthermore, in this example, assume the bond will have a maturity date of Jun. 1, 2019 along with a redemption of $1,000,000 where the frequency is semi-annual such that two payments are made per year. Therefore, the frequency value is two. Finally, the basis in this example is 251, since there are 251 days between Sep. 24, 2018 and Jun. 1, 2019. In this example, the YTM computing device 102 pulls this data from the user account database 104 and uses the function to determine that the initial YTM is 1.7715% in the operation 202.

After the initial YTM is determined in the operation 202, a balance is determined with the YTM value in an operation 204 by the processor of the YTM computing device 102. In accordance with an embodiment of the present disclosure, the balance may be determined in the operation 204 according to the following:

$$\text{bal=bal +} \left(\left(\text{bal*} \left(\text{r} 0 / \& \text{B}\right) \_ \text{Days} \text{.}\right)\right) \text{- Dly\_} \left(\text{Int}\right) \qquad \text{(Equation 1)}$$

In an embodiment, initially, “bal” may refer to the initial amount, i.e., the purchase price of the security. However, it should be noted that in later iterations, as will be discussed further on, “bal” may refer to another value. In an embodiment, “r0” may refer to the YTM, which, initially, refers to the initial YTM determined by the function in the operation 202. Nevertheless, it should be noted that in later iterations, as will be discussed further on, “r0” may refer to a YTM that is calculated separate from the function. “&B_Days.” refers to the number of calendar days while “Dly_Int” refers to the daily interest accrued for the security as a function of the coupon rate for the security. Moreover, the balance is iteratively calculated based on the number of days between the settlement date and the maturity date. For example, if there are 483 days between the settlement date and the maturity date, the balance is iteratively calculated 483 times.

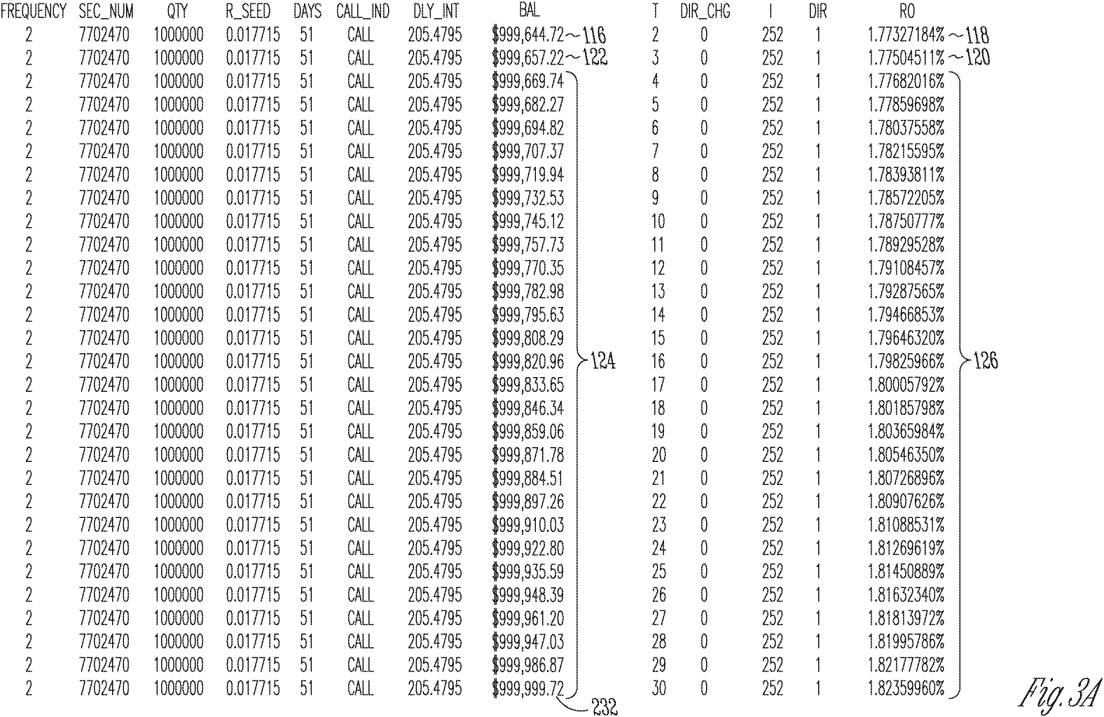

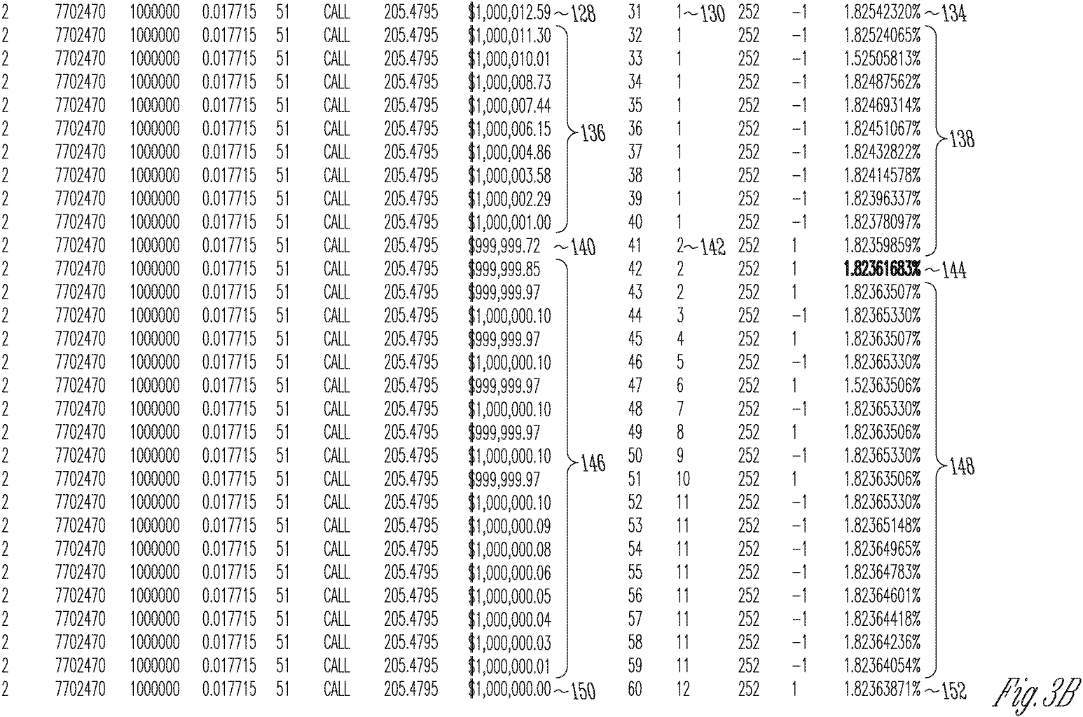

Returning to the example, as noted above, the bond had a purchase price of $1,038,790 on Sep. 24, 2018 and the function calculated the initial YTM as 1.7715%. In addition, the face value of the purchased bond was $1,000,000 with a coupon rate of 7.5%. Thus, the value for the daily interest over 365 days, “Dly_Int,” is 205.4795. Furthermore, the initial value for “bal” will be $1,038,790, which was the purchase price of the security, r0 will be the YTM of 1.7715%, and “&B_Days” will be 365. The balance will be calculated using these values in accordance with Equation 1 above. Furthermore, the bond has a maturity date of Jun. 1, 2019, which is 251 days after Sep. 24, 2018. Therefore, the balance will be iteratively calculated according to Equation 1 251 times in the operation 204. In the example, after the balance is iteratively calculated 251 times, “bal” is equal to a balance 116 having a value of $999,644.72, as shown with reference to FIG. 3A.

After a balance is calculated in the operation 204 with the YTM value determined in the operation 202, the processor of the YTM computing device 102 performs an operation 206, where the balance determined in the operation 204 is compared with the face value of the security. If a determination is made in the operation 206 that the balance determined in operation 204 is less than the face value of the security, the processor of the YTM computing device 102 performs an operation 208. In the operation 208, a determination is made with respect to the number of direction changes that have occurred relative to the face value of the security. For example, in the operation 208, a determination is made regarding how many times the balance determined in the operation 204 has changed relative to the face value of the security. To further illustrate, if the balance determined in the operation 204 has been below the face value three consecutive times and then during a fourth determination the calculated balance exceeds the face value of the security, there has been one direction change. The direction change will have occurred when the determined balance went above the face value of the security from being below the face value. Moreover, should the balance again fall below the face value of the security from above the face value, this will be a second direction change. In the operation 206, if a determination is made that the balance determined in operation 204 is greater than the face value of the security, the processor of the YTM computing device 102 performs an operation 212.

Returning to the example, in the operation 204, the balance was determined to be $999,644.72, which is less than the face value of $1,000,000. Therefore, the method 200 performs the operation 208, where a number of direction changes that have occurred relative the face value is determined. In the example, the initial value is not counted as a direction change in accordance with embodiments of the present disclosure. Thus, the number of direction changes is zero. However, in accordance with embodiments of the present disclosure, should the balance subsequently be determined to be greater than $1,000,000, this will count as the first direction change such that a number of direction changes will be equal to one.

After the number of direction changes has been determined in the operation 208, the processor of the YTM computing device 102 increments the YTM based on a value of the balance relative to the face value and the number of changes in an operation 210. In accordance with embodiments of the present disclosure, when the balance is less than the face value of the security, the YTM is incremented according to one the following increment equations:

$$\text{r0 = r0 + r0*} \text{.001} \qquad \text{(Equation 2)}$$

$$\text{r0 = r0 + r0*} \text{.0001} \qquad \text{(Equation 3)}$$

$$\text{r0 = r0 + r0*} \text{.00001} \qquad \text{(Equation 4)}$$

$$\text{r0 = r0 + r0*} \text{.000001} \qquad \text{(Equation 5)}$$

$$\text{r0 = r0 + r0*} \text{.0000001} \qquad \text{(Equation 6)}$$

$$\text{r0 = r0 + r0*} \text{.00000001} \qquad \text{(Equation 7)}$$

$$\text{r0 = r0 + r0*} \text{.000000001} \qquad \text{(Equation 8)}$$

In accordance with embodiments of the present disclosure, the number of directional changes may determine which of the Equations 2-8 shown above are selected to increment the YTM. It should be noted that r0 equals the YTM. In an embodiment, when there has not been a direction change, Equation 2 may be selected to increment the YTM. In an embodiment, when there has been one direction change, Equation 3 may be selected to increment the YTM. When there have been between two and ten direction changes, Equation 4 may be selected to increment the YTM and when there have been between eleven and twenty-five direction changes, Equation 5 may be selected to increment the YTM, in accordance with embodiments of the present disclosure. If there have been between twenty-six and fifty direction changes, then in an embodiment of the present disclosure, Equation 6 may be selected to increment the YTM. In an embodiment, if there have been between fifty-one and one hundred direction changes, then Equation 7 may be used to increment the YTM while, in instances where there are more than one hundred direction changes, Equation 8 may be used to increment the YTM. Thus, the number of direction changes determines the amount by which the YTM will be incremented.

Returning to the example, as noted above, the number of direction changes is zero. Therefore, the YTM is incremented according to Equation 2 in the operation 210. More specifically, a r0 value 118 of 1.77327184% shown with reference to FIG. 3A is incremented according to Equation 2 such that a newly determined YTM is a r0 value 120 of 1.77504511%.

Once the r0 value 120 is determined in the operation 210, the method 200 repeats the operation 204, where a balance 122 is calculated with the r0 value 120. Furthermore, the operations 206 through 210 along with the operation 204 are repeated in order to generate balances 124 and r0 values 126, as shown with reference to FIG. 3A.

As mentioned above, in the operation 206, if a determination is made that the balance determined in the operation 204 is not less than the face value of the security, the operation 212 is performed, where a determination is made if the balance is greater than the face value of the security. In an embodiment, if the balance determined in the operation 204 is greater than the face value of the security, then the processor of the YTM computing device 102 performs an operation 214, where a number of direction changes relative to the face value is determined. Similar to the operation 208, in the operation 214, a determination is made regarding how many times the balance determined in the operation 204 has either exceeded the face value of the security or has been less than the face value of the security. As mentioned above, if the balance determined in the operation 204 has been below the face value three consecutive times and then during a fourth determination the calculated balance exceeds the face value of the security, there has been one direction change. The direction change will have occurred when the determined balance went above the face value of the security from being below the face value. Moreover, should the balance again fall below the face value of the security from above the face value, this will be a second direction change.

After the number of direction changes has been determined in the operation 214, the processor of the YTM computing device 102 decrements the YTM based on a value of the balance relative to the face value and the number of changes in an operation 216. In accordance with embodiments of the present disclosure, when the balance is greater than the face value of the security, the YTM is decremented according to one the following decrement equations:

$$\text{r0 = r0 - r0*} \text{.001} \qquad \text{(Equation 9)}$$

$$\text{r0 = r0 - r0*} \text{.0001} \qquad \text{(Equation 10)}$$

$$\text{r0 = r0 - r0*} \text{.00001} \qquad \text{(Equation 11)}$$

$$\text{r0 = r0 - r0*} \text{.000001} \qquad \text{(Equation 12)}$$

$$\text{r0 = r0 - r0*} \text{.0000001} \qquad \text{(Equation 13)}$$

$$\text{r0 = r0 - r0*} \text{.00000001} \qquad \text{(Equation 14)}$$

$$\text{r0 = r0 - r0*} \text{.000000001} \qquad \text{(Equation 15)}$$

In accordance with embodiments of the present disclosure, the number of directional changes may determine which of the Equations 9-15 shown above are selected to decrement the YTM. As mentioned above, r0 equals the YTM. In an embodiment, when there has not been a direction change, Equation 9 may be selected to decrement the YTM. In an embodiment, when there has been one direction change, Equation 10 may be selected to decrement the YTM. When there have been between two and ten direction changes, Equation 11 may be selected to decrement the YTM and when there have been between eleven and twenty-five direction changes, Equation 12 may be selected to decrement the YTM, in accordance with embodiments of the present disclosure. If there have been between twenty-six and fifty direction changes, then in an embodiment of the present disclosure, Equation 13 may be selected to decrement the YTM. In an embodiment, if there have been between fifty-one and one hundred direction changes, then Equation 14 may be used decrement the YTM while, in instances where there are more than one hundred direction changes, Equation 15 may be used to decrement the YTM. In other words, the number of direction changes dictates the amount by which the YTM will be decremented.

Returning to the example and FIG. 3A, a balance 128 having a value of $1,000,012.59 was determined in the operation 204. In the operation 206, the method 200 determines that the balance 128 is not less than the face value of the bond, i.e., $1,000,012.59 is greater than $1,000,000, thus the operation 212 is performed, where a determination is made that the balance 128 is greater than the face value of the bond. Accordingly, the operation 214 is performed where a determination is made that one direction change 130 has been made. More specifically, prior to the balance 128 of $1,000,012.59, a balance 132 of $999,999.72 was previously calculated in the operation 204. Since the balance 132 changed from $999,999.72 to the balance 128 of $1,000,012.59, this is a direction change relative to the face value of $1,000,000. Furthermore, this is the first direction change that has occurred. Therefore, in the operation 216, the Equation 10 listed above is used to decrement the YTM to calculate a r0 value 134 of 1.82524065%, as shown with regards to FIG. 3A. After the balance 128 and the r0 value 134 are determined in the operations 204 and 216, the operations 206 through 216 along with the operation 204 are repeated in order to generate balances 136 and r0 values 138, as shown with reference to FIGS. 3A and 3B.

Furthermore, in the example, in the operation 204, a balance 140 having a value of $999,999.72 is calculated. Since the balance 140 having a value of $999,999.72 is less than the face value of $1,000,000, in the operation 208, a determination is made that there have been two direction changes, as indicated by direction change 142. Therefore, in the operation 210, the YTM value is incremented using Equation 4 shown above in order to generate a r0 value 144 of 1.82361683%. Afterwards, the operations 204 through 216 are repeated to generate the balances 146 and the r0 values 148.

Returning to the method 200, the operations 204 through 216 are repeated until the balance calculated in the operation 204 is equal to the face value of the security. Thus, in the operation 206, the balance is determined as not being less than the face value of the security. Additionally, in the operation 212, the balance is determined as not being greater than the face value of the security. Therefore, the processor of the YTM computing device 102 performs an operation 218 where the YTM associated with the balance that is equal to the face value of the security is used to generate either an amortization statement or an accretion statement, which the processor of the YTM computing device 102 outputs in an operation 220. Both the amortization statement and the accretion statement may be displayed on a user device, such as the user devices 112, via the UI 114. In accordance with embodiments of the present disclosure, an amortization statement is generated and output in the operations 218 and 220 when the security is purchased at a premium, i.e., above the face value of the security. Furthermore, in accordance with an embodiment, an accretion statement is generated and output in the operations 218 and 220 when the security is purchased at a discount, i.e., below the face value of the security.

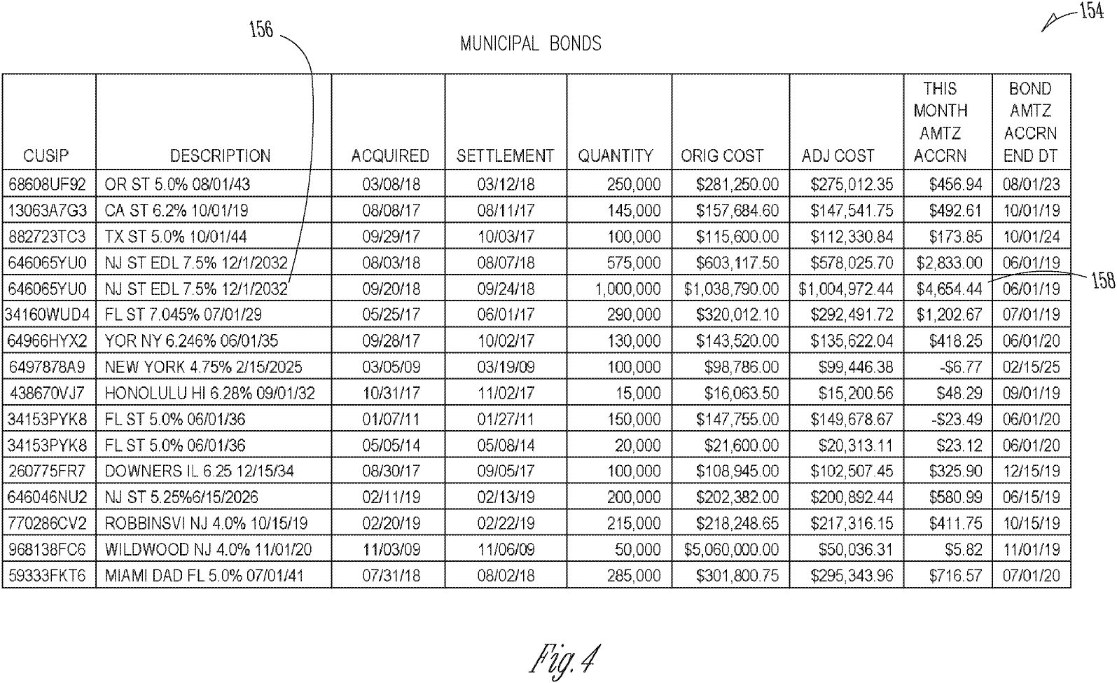

Returning to the example, a balance 150 having a value of $1,000,000 is calculated in the operation 204. In the operation 206, the method determines that the balance is not less than the face value of the bond. Thus, the operation 212 is performed, where a determination is made that the balance is not greater than the face value of the bond. Accordingly, a determination is made that the balance 150 having a value of $1,000,000 is equal to the face value of the bond, which is also $1,000,000. Therefore, the operation 218 is performed where a r0 value 152 of 1.82363871% is the YTM for the bond. In this embodiment, the bond was purchased at a premium, therefore, an amortization statement is generated in the operation 218 using the r0 value 152 as the YTM and output in the operation 220. An example of an amortization statement 154 that may be output and displayed on a device in a UI, such as the user devices 112 and the UI 114 on the user device 112, or any other type of computing device, is shown with reference to FIG. 4.

In the example discussed, a bond having a face value of $1,000,000 was purchased at premium of $1,038,790.00. FIG. 4 illustrates the amortization statement 154 generated for the bond in the example discussed above according to embodiments of the present disclosure. In particular, the statement output shown with reference to FIG. 4 illustrates the bond in the example at 156 having a face value of $1,000,000 that was purchased for $1,038,790. Here, the monthly amortization amount, shown at 158, was generated using the YTM value of 1.82363871%. The amortization amount at 156 may be calculated with the YTM value using any well-known amortization tool, such as those available from costbasis.com located in Chicago, IL and Excel spreadsheet bond amortization calculators available from Microsoft™ located in Redmond, WA.

In accordance with embodiments of the present disclosure, using the YTM calculated with reference to FIGS. 2A and 2B, the amortization, in embodiments where a security was purchased at a premium, may calculated for any given time period. For example, the amortization amount shown at 158 may be calculated for a period of days, a period of months, a period of years, or any other time period. In essence, amortization may be calculated on a daily basis. Therefore, the embodiments disclosed herein are scalable.

Furthermore, the amortization statement 154 may be output using any means. For example, the amortization statement 154 may be a web-based output, a *.jpeg format, a *.pdf format, a *.png format, *.gif, or any other file format. Furthermore, while FIG. 4 illustrates an amortization statement, similar principles apply to an accretion statement. More specifically, while a security purchased for a premium, i.e., purchased above face value, is discussed herein, other securities purchased at a discount, such as below face value, may also employ the methods and systems discussed herein.

In accordance with embodiments of the present disclosure, using the YTM calculated with reference to FIGS. 2A and 2B, the accretion, in embodiments where a security was purchased at a discount, may calculated for any given time period. For example, an accretion may be calculated for a period of days, a period of months, a period of years, or any other time period. Similar to amortization, accretion may be calculated on a daily basis. Therefore, with regards to accretion, the embodiments disclosed herein are scalable.

In accordance with embodiments, amortization and accretion reports may be used for accounting purposes. In scenarios where a security was purchased at a premium, when taking the premium used to purchase the bond and amortizing the premium down against the income received, this may be done in order to adjust earnings of the security to ascertain what is actually earned on the security. The reverse may be done of securities purchased at a discount. These determinations may be used to estimate certain tax liabilities associated with each bond in a given year.

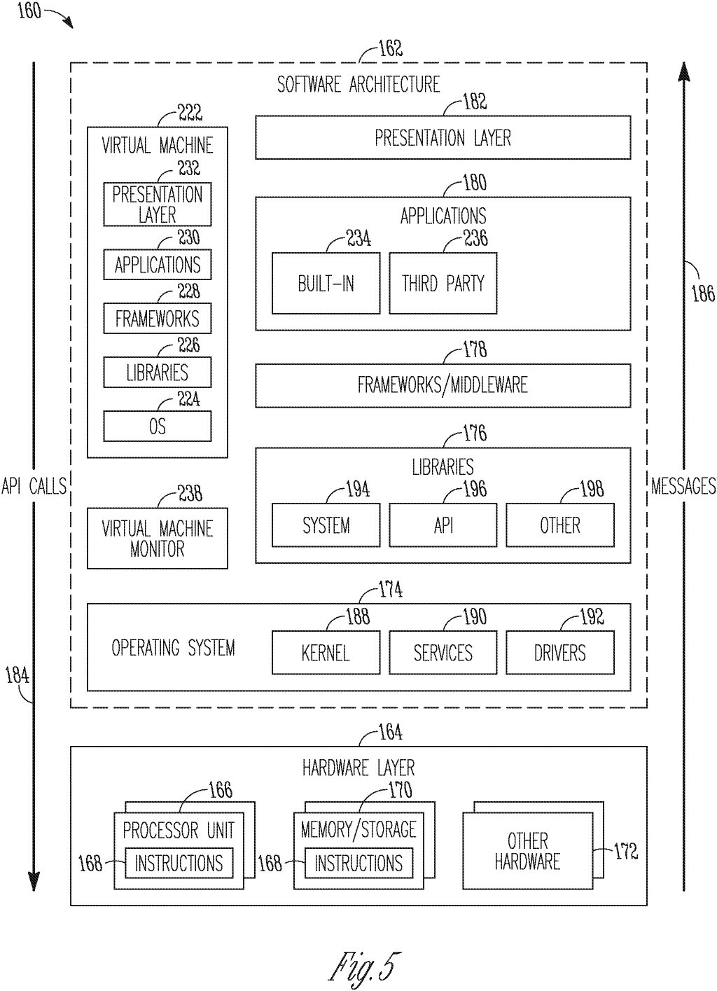

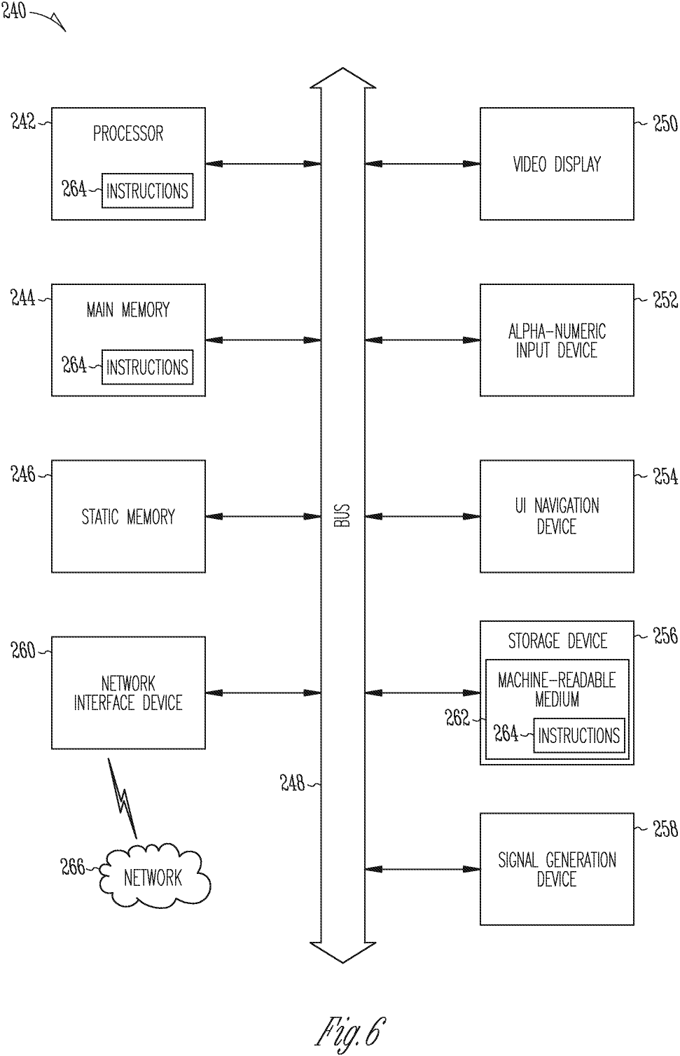

FIG. 5 is a block diagram 160 showing one example of a software architecture 162 for a computing device. The architecture 162 maybe used in conjunction with various hardware architectures, for example, as described herein. FIG. 5 is merely a non-limiting example of a software architecture 162 and many other architectures may be implemented to facilitate the functionality described herein. The software architecture 162 may be executed on hardware such as, for example, any of the systems or subsystems described herein. A representative hardware layer 164 is illustrated and can represent, for example, any of the above referenced computing devices. In some examples, the hardware layer 164 may be implemented according to the architecture 162 of FIG. 5 and/or the architecture 240 of FIG. 6.

The representative hardware layer 164 comprises one or more processing units 166 having associated executable instructions 168. Executable instructions 168 represent the executable instructions of the software architecture 162, including implementation of the methods, systems, components, and so forth of FIGS. 1-4. Hardware layer 164 also includes memory and/or storage modules 170, which also have executable instructions 168. Hardware layer 164 may also comprise other hardware as indicated by other hardware 172 which represents any other hardware of the hardware layer 164, such as the other hardware illustrated as part of hardware architecture 240.

In the example architecture of FIG. 5, the software architecture 162 may be conceptualized as a stack of layers where each layer provides particular functionality. For example, the software architecture 162 may include layers such as an operating system 174, libraries 176, frameworks/middleware 178, applications 180 and a presentation layer 182. Operationally, the applications 180 and/or other components within the layers may invoke application programming interface (API) calls 184 through the software stack and receive a response, returned values, and so forth illustrated as messages 186 in response to the API calls 184. The layers illustrated are representative in nature and not all software architectures have all layers. For example, some mobile or special purpose operating systems may not provide a frameworks/middleware layer 178, while others may provide such a layer. Other software architectures may include additional or different layers.

The operating system 174 may manage hardware resources and provide common services. The operating system 174 may include, for example, a kernel 188, services 190, and drivers 192. The kernel 188 may act as an abstraction layer between the hardware and the other software layers. For example, the kernel 188 may be responsible for memory management, processor management (e.g., scheduling), component management, networking, security settings, and so on. The services 190 may provide other common services for the other software layers. In some examples, the services 190 include an interrupt service. The interrupt service may detect the receipt of a hardware or software interrupt and, in response, cause the architecture 162 to pause its current processing and execute an interrupt service routine (ISR) when an interrupt is received. The ISR may generate the alert, for example, as described herein.

The drivers 192 may be responsible for controlling or interfacing with the underlying hardware. For instance, the drivers 192 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 176 may provide a common infrastructure that may be utilized by the applications 180 and/or other components and/or layers. The libraries 176 typically provide functionality that allows other software modules to perform tasks in an easier fashion than to interface directly with the underlying operating system 174 functionality (e.g., kernel 188, services 190 and/or drivers 192). The libraries 176 may include system libraries 194 (e.g., C standard library) that may provide functions such as memory allocation functions, string manipulation functions, mathematic functions, and the like. In addition, the libraries 176 may include API libraries 196 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 9D in a graphic content on a display), database libraries (e.g., SQLite that may provide various relational database functions), web libraries (e.g., WebKit that may provide web browsing functionality), and the like. The libraries 176 may also include a wide variety of other libraries 198 to provide many other APIs to the applications 180 and other software components/modules.

The frameworks 178 (also sometimes referred to as middleware) may provide a higher-level common infrastructure that may be utilized by the applications 180 and/or other software components/modules. For example, the frameworks 178 may provide various graphic user interface (GUI) functions, high-level resource management, high-level location services, and so forth. The frameworks 178 may provide a broad spectrum of other APIs that may be utilized by the applications 180 and/or other software components/modules, some of which may be specific to a particular operating system or platform.

The applications 180 include built-in applications 234 and/or third-party applications 236. Examples of representative built-in applications 234 may include, but are not limited to, a contacts application, a browser application, a book reader application, a location application, a media application, a messaging application, and/or a game application. Third-party applications 236 may include any of the built-in applications 234 as well as a broad assortment of other applications. In a specific example, the third-party application 236 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 236 may invoke the API calls 184 provided by the mobile operating system such as operating system 174 to facilitate functionality described herein.

The applications 180 may utilize built-in operating system functions (e.g., kernel 188, services 190 and/or drivers 192), libraries (e.g., system libraries 194, API libraries 196, and other libraries 198), frameworks/middleware 178 to create user interfaces to interact with users of the system. Alternatively, or additionally, in some systems, interactions with a user may occur through a presentation layer, such as presentation layer 182. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 5, this is illustrated by virtual machine 222. A virtual machine creates a software environment where applications/modules can execute as if they were executing on a hardware computing device. A virtual machine 222 is hosted by a host operating system (operating system 174) and typically, although not always, has a virtual machine monitor 238, which manages the operation of the virtual machine 222 as well as the interface with the host operating system (i.e., operating system 174). A software architecture executes within the virtual machine 222 such as an operating system 224, libraries 226, frameworks/middleware 228, applications 230 and/or presentation layer 232. These layers of software architecture executing within the virtual machine 222 can be the same as corresponding layers previously described or may be different.

FIG. 6 is a block diagram illustrating the computing device hardware architecture 240, within which a set or sequence of instructions can be executed to cause the machine to perform examples of any one of the methodologies discussed herein. For example, the architecture 240 may execute the software architecture 162 described with respect to FIG. 5. The architecture 240 may operate as a standalone device or may be connected (e.g., networked) to other machines. In a networked deployment, the architecture 240 may operate in the capacity of either a server or a client machine in server-client network environments, or it may act as a peer machine in peer-to-peer (or distributed) network environments. The architecture 240 can be implemented in a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify operations to be taken by that machine.

Example architecture 240 includes a processor unit 242 comprising at least one processor (e.g., a central processing unit (CPU), a graphics processing unit (GPU) or both, processor cores, compute nodes, etc.). The architecture 240 may further comprise a main memory 244 and a static memory 246, which communicate with each other via a link 248 (e.g., bus). The architecture 240 can further include a video display unit 250, an alphanumeric input device 252 (e.g., a keyboard), and a user interface (UI) navigation device 254 (e.g., a mouse). In some examples, the video display unit 250, input device 252 and UI navigation device 254 are incorporated into a touch screen display. The architecture 240 may additionally include a storage device 256 (e.g., a drive unit), a signal generation device 258 (e.g., a speaker), a network interface device 260, and one or more sensors (not shown), such as a global positioning system (GPS) sensor, compass, accelerometer, or other sensor.

In some examples, the processor unit 242 or other suitable hardware component may support a hardware interrupt. In response to a hardware interrupt, the processor unit 242 may pause its processing and execute an interrupt service routine (ISR), for example, as described herein.

The storage device 256 includes a machine-readable medium 262 on which is stored one or more sets of data structures and instructions 264 (e.g., software) embodying or utilized by any one or more of the methodologies or functions described herein. The instructions 264 can also reside, completely or at least partially, within the main memory 244, static memory 246, and/or within the processor unit 242 during execution thereof by the architecture 240, with the main memory 244, static memory 246, and the processor unit 242 also constituting machine-readable media. Instructions 264 stored at the machine-readable medium 262 may include, for example, instructions for implementing the software architecture 162, instructions for executing any of the features described herein, etc.

While the machine-readable medium 262 is illustrated in an example to be a single medium, the term “machine-readable medium” can include a single medium or multiple media (e.g., a centralized or distributed database, and/or associated caches and servers) that store the one or more instructions 264. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 264 can further be transmitted or received over a communications network 266 using a transmission medium via the network interface device 260 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 6G LTE/LTE-A or WiMAX networks). The term “transmission medium” shall be taken to include any intangible medium that is capable of storing, encoding, or carrying instructions (e.g., instructions 264) for execution by the machine, and includes digital or analog communications signals or other intangible medium to facilitate communication of such software.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allows the reader to quickly ascertain the nature of the technical disclosure, for example, to comply with 37 C.F.R. §1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein as embodiments can feature a subset of said features. Further, embodiments can include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

In the following, code is listed that may be used in accordance with some embodiments to implement subject matter disclosed herein. In the following code, the value for BB_PRE_RFND_MTRY_DT IS Jun. 1, 2019 and the value for the RATE is 0.075, in accordance with an embodiment. Furthermore, the value for Carry Bal is 1038790, the value for settlement is Sep. 24, 2018, and the value for Cost_Basis IS 103879 in accordance with an embodiment.

/***********************************************************************************/
/* Bond Amortization and Accretion */
/* */
/* */
/* Written by David P Arans */
/* Desc: This code determines the monthly amortization or accretion for corporate */
/* and municiple bond holdings using the a client’s cost basis information */
/* and the attributes for each bond. Logic is used to the determine the */
/* lowest of call date, prepayment date, or maturity. A simulation is used */
/* to calculate the actual YTM to create the daily */
/* amortization/accretion that gets to the face value. */
/***********************************************************************************/*/
/* Basis for Yield */
/* 0 “30/360” */
/* 1 “ACTUAL” */
/* 2 “ACT/360” */
/* 3 “ACT/365” */
/* 4 “EU3C */
/* Set Basis */
%Let Basis= “ACT/365”;
%Put & Basis;
%Let B_Days= 3S5;
%Put & B_Days;
Data BOND_INFO_2;
Set BOMDJNFO.
Where SEC_CUSIP_NUM=“646065YUG And Face_Value = 1000000;
Format Bond_Cal_End_Dt Date9.0;
/*Fill in empty Settlement Dates with Trade Date*/
if settlement =. Then settlement = TAXL_OPEN_DT;
/* Determine the date that should be used for the amrtz/acren */
/* Rule 1-Use Maturity Date --MTRY */
if((SEC_Fll /* Not Being Called */
And BB_SEC_CALL_DT =. /* Not Being Called in BB Table */
And Fir_CallBL_Dt_Hist=. /* No Call History in SEC_DIM Table */
And Rate *=0) /* Rateis not -missing */
Or Cost_Basis < Face_Value)/* Not Purchased above Par*/
And (BB_PRE_RFND_MTRY_DT = Maturity
Or BB_PRE_RFND_MTRY_DT =.) /* Not Being Prerefunded */
And SEC_TYP_CD In |‘B’,‘M’| /* Bond or Muni */
Then Do;
f_seed=finance|‘yield’, settlement, maturity, rate, pr, redemption, input(frequency,comma10.0), &Basis.);
days = datdif(settlement,maturity,&Basis.)+1;
Call_Ind = ‘MTRY’;
Bond_Cal_End_Dt = Maturity;
End;
/* Rule 2 - Use Prerefunded Date- PRFN */
Else If((SEC_FIR_CALL_DT=. /* Not Being Called */
And BB_SEC_CALL_DT = ./*Not Being Called in BB Table */
And: Fir_CellBL_Dt_Hist=./*NoCall History in SEC_DIM Table */
And: Rare ^= O) /* Rate is not missing */
Or Cost _Basis<Face_Value)/*Not Purchased above Par */
And: BB_PRE_RFND_MTRV_DT<Maturity /* Being Prerefunded */
And: {Fir_Callbi_Dt_Hist =, Or BB_PRE_MTRY_DT<Fir_Callbi_Dt_Histj/* is earlier than Fir_Call*/
And [BB_SEC_CALL_DT= Or BB_PRE_ RFND_MTRY_DT < BB_SEC_CALL_DT)/*is earlier than BB_CALL_DT*/
And SEC_TYP_CDIn {‘B’,‘M’} /* Bond or Muni*/
Then Do;
r_seed=finance{yiale; settlement,BB_PRE_RFND_MTRY_DT, rate, pr, redemption, input{frequency,comma10.0},&Basis.},
days=datdif(settlement, BB_PRE_RFND_MTRY_DT, &Basis.)+1;
Call_Ind = PRFN′:
Bond_Cal_End_Dt= BB_PRE_RFND_MTRY_DT;
End;
/* Rule3 - Use1stcall date past settlement date */
Else if [[BB_SEC_CALL_DT^=, And BB_SEC_CALL_DT> settlement) /*Being Called */
Or {BB_SEC_Call_DT= And FIR_Callbl_Dt_Hist>settlement}}
Or {BB_SEC_CAll_DT= And SEC_FIR_CALL_DT>settlement))
Or(BB_SEC_CALL_DT<Settlement And SEC_FIR_CALL_DT=>settlement))
And: [SEC_TVF_CD IN (‘B’,‘M’)/*Bond or Muni */
And Fate: ^=0) /* Rate is not missing */
Then Do;
If Fir_Callbl_DR_Hist=. Or
(Fir_Callbl_Dt_Hist *= And BB_SEC_CALL_DT^=. And FIR_Callbl_Dt_Hist=> BB_SEC_CALL_DT)Then
Do;
r_seed = finance[yield; settlement, BB_SEC_CALL_DT, rate, pr, redemption, input(frequency,comma10.0),& Basis, },
days = datdif(settlement, BB_SEC_CALL_DT,&Basis.) +1;
Bond_Cal_End_Dt= BB_SEC_CALL_DT;
End;
Else if [BB_SEC_CALL_DT ^= And FIR_Callbl_Dt_Hist <BB_SEC_CALL_DT)
Dt {BB_SEC_CALL_DT= And FIR_Callbl_DT_Hist^= ) Then
Do;
r_seed = finance[yield;settlement, FIR_Callbl_Dt_Hist, rate, pr, redemption,input[frequency,comma 10.0]&Basis.}
days=datdif(settlement,FIR_Callbl_Dt_Hist,&Basis)+1,
Bond_Cal_End_Dt = FIR_Callbl_Dt_Hist,
End;
Else If(BB_SEC_CALL_DT = And SEC_FIR_CALL_DT>settlement) Then
Do;
r_seed = finance(‘yield’, settlement, SEC_FIR_CALL_DT, rate, pr, redemption, input[frequency, comma10.0], &Basis.);
days =datdif(settlement, SEC_FIR_CALL_DT, &Basis.)+1;
Bond_Cal_End_Dt=SEC_FIR_CALL_DT;
End;
Else if [BB_SEC_CALL_DT < settlement And SEC_FIR_CALL_DT =>settlement] Then
Do;
r_seed=finance(‘yield’, settlement, SEC_FIR_CALL_DT, rate, pr, redemption, input[frequency,comma 10.0],&Basis.);
days=detdif(settlement, SEC_FIR_CALL_DT,&Basis.)+1;
Bond_Cal_End_Dt = SEC_FIR_CALL_DT;
End;
Call_Ind=Call′,
End;
/* Set up values for Daily Interest, Carry Balance, Balance Macro, (tjloop internal, and (dir_chg) direction change */
Dly_Int = [Face_Value *Rate] /&B_Days.;
Carry_Bal =Cost_Basis;
bal=Carry_Bal;
r=1;
Dir_Chg=0.
/*First YTMCheck*/
If SEC_TYP_CD IN[‘B’,‘M’) And Rate ^=0
Then
Do;
/* Loop to get seed balance value using the YTM estimate SAS determined */
Do i = 1 to Days by 1;
bal=bal +((bal*(r_seed/&B_Days.)) - Dly_Int);
End;
/* Set the intial direction for movement*/
If bal < Face_Value Then dir =1; Else dir =-1;
/********************************************************/
/* Simulator to get actual YTM *************************/
/* Loop will fine tune the YTM *************************/
Do Until ((Round(bel,.01) = Face_Value) Or (t= 5000));
/* Set Inital interest Rate */
If t = 1 Then r0 = r_seed;
/* Logic for the next YTM change */
If bal < Face_Value And Dir_Chg=0 Then
r0=r0+r0*.001;
Else if bal > Face_Value And Dir_Chg0 Then
r0=rs-r0*.001;
Else If bal < Face_Value And Dir_Chg= 1 Then
r0=r0+r0*.0001;
Else if bal > Face_ValueAndDir_Chg=1 Then
r0=r0+r0*.0001;
Else if bal < Face Value And [Dir Chg=2 And Dir Chg<=10]Then
r0=r0+r0*.00001
Else if bal < Face Value And [Dir Chg>=2 And Dir Chg<=10]Then
r0=r0+r0*.00001;
Else if bal < Face_ValueAnd [Dir_Chg>=11 And Dir_Dhg <= 25] Then
r0=r0+r0*.000001;
Else If bal > Face _Value And [Dir_Chg>=11 And Dir_Chg <=25] Then
r0=r0+r0*.000001;
Else if bal < Face_Value And [Dir_Chg >=26 And Dir_Chg<= 50] Then
r0=r0+r0*.000001
Else if bal < Face Value And [Dir Chg>=26And Dir Chg<=50]Then
r0=r0+r0*.0000001;
Else if bal < Face_Value And [Dir Chg>=51And Dir Chg<=100]Then
r0=r0+r0*.00000001;
Else if bal > Face_Value And [Dir_Chg>= 51 And Dir_Chg <= 100] Then
r0=r0+r0*.00000001;
Else if bal < Face_Value And Dir_Chg > 100 Then
r0=r0+r0*.000000001;
Else if bal > Face_Value And Dir_Chg > 100 Then
r0=r0+r0*.000000001;
/* Rerun with new YTM */
bal =Carry_Bal;
Do l = 1to Days by 1;
bal=bal + ((bar*(r0/BB_Days)) - Dly_Int);
End;
r = t+1;
bal_cm= Face_Value;
Amrtzn_cm= 0;
End;
Else if Call_Ind ln (‘MTRY’, ‘PRFN’, ‘CALL’) And Bond_Cal_End_Dt >=&cal_eom_dt
Then
Do;
day_cm=datdif(settlement,&cal_eom_dt.,&Basis)+1;
bal_cm = Carry_Bal;
Do i = 1 to day_cm by 1;
bal_cm = + ((bal_cm*(r0/&8_Days_)) - Dly_Int);
End;
Amrtzn_cm = Cost_Basis - bal_cm;
End;
Else if Call_Ind In (‘MTRY’,‘PRFN’,‘CALL’) And Bond_Call_End_Dt < &cal_eom_dt.
Then
Do;
day_cm=datdif(settlement,Bond_Cal_End_Dt,&Basis)+1;
bal_cm = Carry_Bal;
Do i = 1 to day_cm by 1;
bal_cm = bal_cm+((bal_cm*(rO/&B_Days.))-Dly_Int);
End;
Amrtzn_cm = Cost_Basis - bal_cm;
End;
Mnth_Amrtzn =bal_lm - bal_cm;
End; /* This is the end statement to have it ignore non-bonds */
/* Add in values for missing adjusted cost */
If SEC_TYP_CD In (‘B’,‘M’) And Bal_Cm =. Then
Do;
Bal_cm=Cost_Basis;
Mnth_Amrtzn = 0;
End;
Run;
/* Update Direction indicator to increment dir_chg */
If (Bal > Face_Value And dir = 1) Or (Bal: < Face_Value And dir = -1) Then
Do;
Dir_Chg = Dir_Chg + 1;
If Bal > Face_Value Then dir = -1.;
Else If Bal < Face_Value Then dir = 1;
End;
/* See simulator steps */
Output;
End;
/*Output*/
/*Get Output Values */
/******************************************/
/* Value for the last day of previous month */
/******************************************/
* Last Month */
If Call_Ind In (‘MTRY’,‘PRFN’,‘CALL’) And Bond_Cal_End_Dt <= &cal_som_dt_prior.
Then
Do;
bal_Im = Face_Value
Amrtzn_Im =0;
End;
Else if Call_Ind In (‘MTRY’,‘PRFN’,‘CALL’)And Bond_Cal_End_Dt >=&cal_eom_dt_prior.
Then
Do;
day_lm=datdif(settlement,&cal_eom_dt_prior,&Basis)+1;
bal_lm = Carry_Bal;
Do i = 1 to day_Im by 1;
bal_lm = bal_lm + ((bal_lm*(rO/&B_Days.))- Dly_Int);
End;
Amrtzn_lm = Cost_Basis - bal_lm;
End;
Else if Call_Ind In (‘MTRY’,‘PRFN’,‘CALL’) And Bond_Cal_End_Dt <&cal_eom_dt_prior.
Then
Do;
day_lm = datdif[settlement,Bond_Cal_End_Dt,&Basis] + 1;
bal_lm = Carry_Bat;
Do i = 1 to day_lm by 1;
bal_lm = bal_lm + ((bal_lm*(rO/&B_Days.))-Dly_Int);
End;
Amrtzn_lm = Cost_Basis - bal_lm;
End;
/******************************************/
/* Value for the last day of current month */
/******************************************/
/* Current Month */
If Call_lnd In (‘MTRY’,‘PRFN’,‘CALL’) And Bond_Cal_End_Dt <= &cal_som_dt.
Then
Do;
bal_cm = Face_Value;
Amrtzn_cm = O;
End;
Else If Call_lnd In (‘MTRY’,‘PRFN’,‘CALL’) And Bond_Cal_End)Dt >=&cal_eom_dt.
Then
Do;
day_cm=datfif[settlement,&cal_eom_dt.,&Basis]+1;
bal_cm = Carry_Bal;
Do i = 1 to dsy_cm by 1;
End; bal_cm = + ((bal_cm*(r0/&8_Days.)) - Dly_Int);
Amrtzn_cm=Cost_Basis-bal_cm;
End;
Else If Call_Ind In (‘MTRY’,‘PRFN’,‘CALL’) And Bond_Cal_End_Dt<&cal_eom_dt.
Then
Do;
day_cm = datdif[settlement,Bond_Cal_End_Dt,&Basis]+1;
bal_cm = Carry_Bal;
Do i = 1 to day_cm by 1;
bal_cm=bal_cm+((bal_cm*[r0/&B_Days.))-Dly_Int);
End;
Amrtzn_cm = Cost_Basis - bal_cm;
End;
Mnth_Amrtzn =bal_lm - bal_cm;
End; /* This is the end statement to have it ignore non-bonds */
/* Add in values for missing adjusted cost */
If SEC_TYP_CD In (‘B’,‘M’) And Bal_Cm =. Then
Do;
Bat_cm = Cost_Basis;
Mnth_Amrtzn = 0;
End;
Run;

1. A method of operating a yield to maturity (YTM) device for a security having a face value and a purchase price, the method comprising:
(A) determining, at a processor of the YTM device, a YTM value associated with the security based on the face value, the purchase price, a settlement date of the security, and a maturity date of the security;
(B) iteratively determining, at the processor of the YTM device, a balance based on the YTM value and a time period between the security settlement date and the security maturity date, wherein the balance is iteratively determined for each day of the time period;
(C) comparing, at the processor of the YTM device, the balance with the face value of the security;
(D) based on the comparison, determining, at the processor of the YTM device, a number of times the balance has either exceeded the face value or has been less than the face value, wherein a direction change occurs when the balance changes from either exceeding the face value to being less than the face value or changes from being less than the face value to exceeding the face value;
(E) adjusting, at the processor of the YTM device, the YTM value based on:
the number of times the balance has exceeded the face value and the number of times the balance has been less than the face value; and
a value of the balance relative to the face value, wherein the adjustment based on the number of times the balance has exceeded the face value and the number of times the balance has been less than the face value is done in real time;
(F) generating, at the processor of the YTM device in an output format suitable for display on a computing device, a statement based on the adjusted YTM value, the face value, and the purchase price; and
(G) outputting, from the processor of the YTM device, the statement for display on a user device in the output suitable for display on the computing device.

2. The method of claim 1, wherein when the balance changes from exceeding the face value to being less than the face value, the YTM value is adjusted by increasing the YTM value.

3. The method of claim 2, wherein the number of times the balance has exceeded the face value and the number of times the balance has been less than the face value determines an amount by which the YTM value is increased.

4. The method of claim 2, wherein (B) through (E) are repeated after increasing the YTM value.

5. The method of claim 4, wherein when the balance changes from being less than the face value to exceeding the face value, the YTM value is adjusted by decreasing the YTM value.

6. The method of claim 5, wherein the number of times the balance has exceeded the face value and the number of times the balance has been less than the face value determines an amount by which the YTM value is decreased.

7. The method of claim 5, wherein (B) through (E) are repeated after decreasing the YTM value.

8. The method of claim 1, wherein when the balance changes from being less than the face value to exceeding the face value, the YTM value is adjusted by decreasing the YTM value.

9. The method of claim 8, wherein (B) through (E) are repeated after decreasing the YTM value.

10. The method of claim 9, wherein when the balance changes from exceeding the face value to being less than the face value, the YTM value is adjusted by increasing the YTM value.

11. The method of claim 10, wherein (B) through (E) are repeated after increasing the YTM value.

12. The method of claim 1, wherein the operation (E) further comprises:
decreasing the YTM value when the balance increases to a value that is higher than the face value; and
increasing the YTM value when the balance decreases to a value that is lower than the face value.

13. The method of claim 1, wherein (F) and (G) are performed when a value of the balance equals the face value.

14. A non-transitory, machine-readable medium, comprising instructions, which when performed by a processor of a machine, causes the processor to perform operations to:
(A) determine a yield to maturity (YTM) value associated with a security based on a face value of the security, a purchase price of the security, a settlement date of the security, and a maturity date of the security;
(B) iteratively determine a balance based on the YTM value and a time period between the security settlement date and the security maturity date, wherein the balance is iteratively determined for each day of the time period;
(C) compare the balance with the face value of the security;
(D) based on the comparison, determine a number of times the balance has either exceeded the face value or has been less than the face value, wherein a direction change occurs when the balance changes from either exceeding the face value to being less than the face value or changes from being less than the face value to exceeding the face value;
(E) adjust the YTM value based on:
the number of times the balance has exceeded the face value and the number of times the balance has been less than the face value; and
a value of the balance relative to the face value, wherein the adjustment based on the number of times the balance has exceeded the face value and the number of times the balance has been less than the face value is done in real time;
(F) generate in an output format suitable for display on a computing device, a statement based on the adjusted YTM value, the face value, and the purchase price; and
(G) output the statement for display on a user device in the output suitable for display on the computing device.

15. The non-transitory, machine-readable medium of claim 14, wherein when the balance changes from exceeding the face value to being less than the face value, the YTM value is adjusted by increasing the YTM value.

16. The non-transitory, machine-readable medium of claim 15, wherein the number of times the balance has exceeded the face value and the number of times the balance has been less than the face value determines an amount by which the YTM value is increased.

17. The non-transitory, machine-readable medium of claim 15, wherein (B) through (E) are repeated after increasing the YTM value.

18. The non-transitory, machine-readable medium of claim 14, wherein the operation (E) further comprises:
decreasing the YTM value when the balance increases to a value that is higher than the face value, and
increasing the YTM value when the balance decreases to a value that is lower than the face value.

19. The non-transitory, machine-readable medium of claim 14, wherein (F) and (G) are performed when a value of the balance equals the face value.

20. A system comprising:
processing circuitry; and
a memory device including instructions embodied thereon, wherein the instructions, which when executed by the processing circuitry, configure the processing circuitry to perform operations that:
(A) determine a yield to maturity (YTM) value associated with a security based on a face value of the security, a purchase price of the security, a settlement date of the security, and a maturity date of the security;
(B) iteratively determine a balance based on the YTM value and a time period between the security settlement date and the security maturity date, wherein the balance is iteratively determined for each day of the time period;
(C) compare the balance with the face value of the security;
(D) based on the comparison, determine a number of times the balance has either exceeded the face value or has been less than the face value, wherein a direction change occurs when the balance changes from either exceeding the face value to being less than the face value or changes from being less than the face value to exceeding the face value;
(E) adjust the YTM value based on:
the number of times the balance has exceeded the face value and the number of times the balance has been less than the face value; and
a value of the balance relative to the face value, wherein the adjustment based on the number of times the balance has exceeded the face value and the number of times the balance has been less than the face value is done in real time;
(F) generate in an output format suitable for display on a computing device a statement based on the adjusted YTM value, the face value, and the purchase price; and
(G) output the statement for display on a user device in the output suitable for display on the computing device.

21. The system of claim 20, wherein when the balance changes from exceeding the face value to being less than the face value, the YTM value is adjusted by increasing the YTM value.

22. The system of claim 21, wherein the number of direction changes of the balance determines an amount by which the YTM value is increased.

23. The system of claim 21, wherein (B) through (E) are repeated after increasing the YTM value.

24. The system of claim 20, wherein the operation (E) further comprises:
decreasing the YTM value when the balance increases to a value that is higher than the face value; and
increasing the YTM value when the balance decreases to a value that is lower than the face value.

25. The system of claim 20, wherein (F) and (G) are performed when a value of the balance equals the face value.
